(19) United States
(12) Patent Application Publication
(10) Pub. No.: US 2008/0081126 A1
(43) Pub. Date: Apr. 3, 2008

(54) Method for forming a dielectric film on a substrate

(76) Inventors: Chu-Liang Ho, Taichung Export Processing Zone (TW); Wen-Li Lo, Taichung Export Processing Zone (TW)

Correspondence Address: HARNESS, DICKEY & PIERCE, P.L.C., P.O. BOX 8910, RESTON, VA, 20195, US

(21) Appl. No.: 11/529,307

(22) Filed: Sep. 29, 2006

(51) Int. Cl. H05H 1/24

(52) U.S. Cl. 427/569

(57) ABSTRACT

A method for forming a dielectric film on a substrate through reaction of a reactant mixture in a deposition chamber, the reactant mixture being dissociated and ionized by a plasma generated in the deposition chamber. In particular, the method includes applying a first working voltage of a first polarity to an electrode in the deposition chamber for enabling dissociation and ionization of the reactant mixture, and removing undesired electrical charge accumulated on the deposited dielectric film on the substrate by for example, applying a second working voltage of a second polarity to the electrode.

### BACKGROUND OF THE INVENTION

1. Field of the Invention

This invention relates to a method for forming a dielectric film on a substrate, more particularly to a method form forming a dielectric film by using plasma to dissociate and ionize a reactant mixture, and removing undesired electrical charges accumulated on the dielectric film.

2. Description of the Related Art

Since bathroom products are used in a humid environment and are frequently washed or cleaned through alkaline or acidic detergents, the bathroom products are required to be wear-resistant and corrosion-resistant.

The bathroom products are generally manufactured by applying a transparent plastic lacquer coating on a substrate so as to avoid direct contact of the substrate with the humid environment or the alkaline or acidic detergents used for a cleaning or washing treatment. However, the transparent plastic lacquer coating has a relatively poor hardness, wear resistance, and low durability of thermal cycles, tends to be fingerprinted, and is heat-intolerant. In addition, use of many poisonous substances in the manufacturing process tends to cause pollution problems.

Regarding conventional methods for forming a corrosion-resistant coating of organic polymers on a metallic substrate, U.S. Pat. No. 5,437,725 (hereinafter referred to as the '725 patent) discloses a device for continuously coating a metallic material in motion with a polymer deposition. The device is useful for carrying out a continuous coating process through plasma-enhanced chemical vapor deposition (PECVD) techniques. In particular, the continuous coating process includes: (a) introducing a gaseous monomer of a polymer to be deposited, for example hexamethyldisiloxane (HMDSO), into a chamber under a reduced pressure; (b) continuously moving a metallic strip through spaces separately defined by first, second and third rollers and the corresponding first, second and third electrodes, each of the first, second and third electrodes being connected to a power supply, the second roller being mounted with permanent magnets for accelerating dissociation of the monomer of the polymer to be deposited in the space defined by the second roller and the second electrode; and (c) using the metallic strip as a cathode, while using the electrodes as anodes so that a predominantly organic first layer, a more inorganic second layer, and a predominantly organic third layer are sequentially formed on the metallic strip due to potential differential between the cathode and the respective anodes generated by the power supply.

U.S. Pat. No. 6,737,121 (hereinafter referred as the '121 patent) discloses a method for depositing a plurality of layers on a substrate of a polymer resin. The method of the '121 patent includes the steps of: introducing a plasma gas into a plasma generation chamber in communication with a deposition chamber, the substrate being placed in the deposition chamber; generating an arc in the plasma generation chamber for creating a plasma to flow into the deposition chamber; injecting a first material containing a first oxidant and an organosilicon material into the plasma so as to form a polymerized-organosilicon interlayer on the substrate; and injecting a second material containing a second oxidant, an elemental metal and an organometallic compound into the plasma so as to form an inorganic ultraviolet-absorbing layer on the interlayer. A third material may be further injected into the plasma so as to form an abrasion-resistant layer on the inorganic ultraviolet-absorbing layer.

### SUMMARY OF THE INVENTION

The object of the present invention is to provide a method for forming a dielectric film on a substrate, the dielectric film thus formed having not only a satisfactory transparency but also corrosion resistance and abrasion resistance.

According to one aspect of this invention, a method for forming a dielectric film on a substrate through reaction of a reactant mixture in a deposition chamber, in which the reactant mixture is dissociated and ionized by a plasma generated in the deposition chamber, includes applying a bipolar pulse to an electrode in the deposition chamber such that the bipolar pulse has a cycle time including a first period of a first working voltage of a first polarity for enabling dissociation and ionization of the reactant mixture, and a second period of a second working voltage of a second polarity for removing undesired electrical charges accumulated on the deposited dielectric film on the substrate. The second polarity is opposite to the first polarity.

According to another aspect of this invention, a method for forming a dielectric film on a substrate through reaction of a reactant mixture in a deposition chamber, in which the reactant mixture is dissociated and ionized by a plasma generated in the deposition chamber, includes: applying a first working voltage of a first polarity to an electrode in the deposition chamber for enabling dissociation and ionization of the reactant mixture; and removing undesired electrical charges accumulated on the deposited dielectric film on the substrate.

### BRIEF DESCRIPTION OF THE DRAWING

Other features and advantages of the present invention will become apparent in the following detailed description of the preferred embodiments of this invention, with reference to the accompanying drawing, in which:

FIG. 1 is a voltage versus time plot to illustrate how a bipolar pulse is applied during a cycle time according to the preferred embodiment of a method for forming a dielectric film on a substrate according to this invention.

### DETAILED DESCRIPTION OF THE PREFERRED EMBODIMENTS

In order to fulfill high transparency, abrasion and corrosion resistance, and substantially free of light interfering effect required for the coating formed on bathroom products, ionization of the organosiloxanes used in formation of the coating can be enhanced by increasing the applied working voltage to an electrode in a PECVD deposition chamber. However, the inventors discovered that the coating thus made is a dielectric film, and undesired electrical charges tend to accumulate on surface of the dielectric film during application of a uni-polar pulsed powder to the electrode in the deposition chamber, which results in generation of arc. Consequently, the deposition of the dielectric film is hindered by the generated arc and the dielectric film cannot be formed as desired.

According to the first preferred embodiment of a method for forming a dielectric film on a substrate of this invention, the dielectric film is formed on the substrate through reaction of a reactant mixture in a deposition chamber. The reactant mixture is dissociated and ionized by a plasma generated in the deposition chamber. In particular, the method of the first preferred embodiment of this invention includes applying a first working voltage of a first polarity to an electrode in the deposition chamber for enabling dissociation and ionization of the reactant mixture; and removing undesired electrical charges accumulated on the deposited dielectric film on the substrate.

Preferably, application of the first working voltage to the electrode is conducted intermittently, and removal of the undesired electrical charges accumulated on the deposited dielectric film is conducted at the interval of the application of the first working voltage. More preferably, the first polarity of the first working voltage is a negative polarity. For example, the first working voltage may range from −100 V to −400 V. Preferably, the first working voltages ranges from −100 V to −300 V.

The removal of the undesired electrical charges accumulated on the deposited dielectric film may be conducted by applying a second working voltage of a second polarity opposite to the first polarity to the electrode. Preferably, the second working voltage has a positive polarity and ranges from larger than 0 V to +75 V.

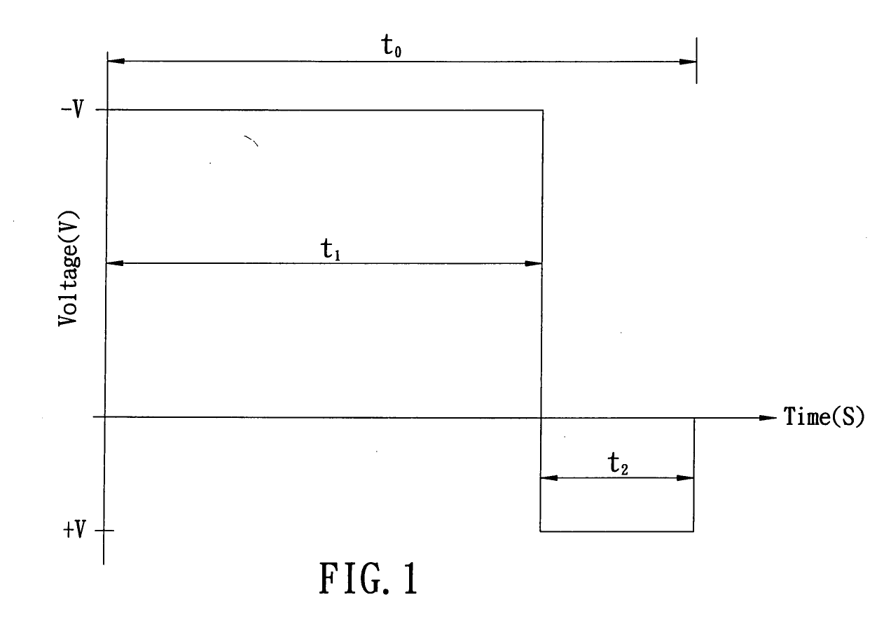

According to the second preferred embodiment of a method for forming a dielectric film on a substrate of this invention, similar to the first preferred embodiment, the dielectric film is formed on the substrate through reaction of a reactant mixture in a deposition chamber, and the reactant mixture is dissociated and ionized by a plasma generated in the deposition chamber. In particular, the method of the second preferred embodiment includes applying a bipolar pulse to an electrode in the deposition chamber such as that shown in FIG. 1. The bipolar pulse has a cycle time (t₀) including a first period (t₁) of a first working voltage of a first polarity for enabling dissociation and ionization of the reactant mixture, and a second period (t₂) of a second working voltage of a second polarity for removing undesired electrical charges accumulated on the deposited dielectric film on the substrate. The second polarity is opposite to the first polarity.

Preferably, the bipolar pulse has a duty cycle (t₁/t₀×100%) defined as the ratio of the first period (t₁) to the cycle time (t₀) and ranging from 40 to 95%. More preferably, the duty cycle ranges from 60 to 95%. Most preferably, the duty cycle ranges from 80 to 95%.

Preferably, the bipolar pulse has a frequency equal to the inverse of the cycle time and ranging from 10 to 250 kHz. That is, the cycle time of the bipolar pulse ranges from 4 μs to 100 μs. More preferably, the bipolar pulse has a frequency equal to the inverse of the cycle time and ranging from 30 to 250 kHz. That is, the cycle time of the bipolar pulse ranges from 30 μs to 100 μs.

Preferably, the first working voltage has a negative polarity and ranges from −100 V to −400 V. More preferably, the first working voltage ranges from −100 V to −300 V.

Preferably, the second working voltage has a positive polarity and ranges from larger than 0 V to +75 V. Since the cycle time of the method of the second preferred embodiment of this invention is relatively short, the positive polarity of the second working voltage can accelerate removal of the undesired electrical charges accumulated on the deposited dielectric film on the substrate.

In addition, in the first and second preferred embodiments of the method for forming the dielectric film on a substrate according to this invention, the reactant mixture includes an oxidant, a carrier gas and an organosilicon material carried by the carrier gas to flow into the deposition chamber. More preferably, the oxidant is selected from the group consisting of an oxygen gas and an ozone gas, and the organosilicon material is selected from the group consisting of tetramethyldisiloxane (TMDSO) and hexamethyldisiloxane (HMDSO).

In one of non-limiting example of the reactant mixture, the oxidant is oxygen gas, the organosilicon material is tetramethyldisiloxane (TMDSO), and the carrier gas is argon gas. It is noted that in this example, the volume flow rate of the oxygen gas to the argon gas tends to influence transparency of the dielectric film and efficiency of formation of the dielectric film. If the volume flow rate of the oxygen gas to the argon gas is too low, the transparency of the dielectric film will be adversely effected. If the volume flow rate of the oxygen gas to the argon gas is too high, the efficiency of formation of the dielectric film will decrease. Preferably, the volume flow rate of the oxygen gas to the argon gas ranges from 1:2 to 2:1. More preferably, the volume flow rate of the oxygen gas to the argon gas ranges from 1:2 to 1:1.

Preferably, the organosilicon material is carried by the carrier gas to flow into the deposition chamber at room temperature under 1 atm.

Preferably, the deposition chamber is maintained in a working pressure ranging from 1 Pa to 100 Pa during application of the bipolar pulse to the electrode in the deposition chamber. More preferably, the deposition chamber is maintained in a working pressure ranging from 1 Pa to 10 Pa.

It is noted that the amount of the first working voltage is not limited to the preferred range mentioned in the text. Increase of the first working voltage enhances dissociation and ionization of the reactant mixture. Besides, increase of a working temperature of the substrate improves diffusion ability of the dissociated and ionized reactant mixture so as to strengthen adhesion of the dielectric film thus formed to the substrate, and so as to improve compactness and uniformity of the dielectric film thus formed.

It is also noted that the amount of the working voltage, either the first working voltage or the second working voltage, depends upon the material of the substrate. When the substrate is made from a polymer, the amount of the first working voltage can be reduced to avoid any damage to the substrate. On the other hand, when the substrate is made from metallic or ceramic material, the amount of the first working voltage can be increased provided that the duty cycle of the bipolar pulse has been decreased to a proper value.

### EXAMPLE 1

A showerhead made from acrylonitrile-butadiene-styrene (ADS) was used as a substrate. A nickel (Ni) layer having a thickness of about 10 μm and a chromium (Cr) layer having a thickness of about 0.1 μm to 0.2 μm were sequentially formed on the showerhead. The showerhead was subsequently subjected to oxygen plasma treatment so as to remove contaminants present in the surface of the Cr layer. Next, the showerhead was placed on an electrode in a PECVD chamber.

A bipolar pulse with a cycle time of 4 μs was applied to the electrode in the PECVD chamber. The cycle time of the bipolar pulse included the first period of applying a negative working voltage of −100 V for 3597 ns, and the second period of applying a positive working voltage of +75 V for 403 ns. Therefore, the duty cycle of the bipolar pulse was 90%.

A reactant mixture including TMDSO, O₂ and Ar was injected into the PECVD chamber. The volume flow rate of O₂ to Ar was set to 1, and TMDSO was carried by an Ar gas having a flow rate of 250 sccm at room temperature under 1 atm so as to flow into the PECVD chamber and so as to maintain the working pressure of the PECVD chamber at 7 Pa.

The showerhead was treated in the PECVD chamber for 90 minutes, and a transparent dielectric film having a thickness ranging from 3.8 μm to 4.0 μm was deposited on the Cr layer on the showerhead. The dielectric film thus formed has excellent transparency, abrasion resistance and corrosion resistance.

### EXAMPLE 2

A transparent dielectric film having a thickness of about 7 μm was deposited on a middle escutcheon of a faucet, which was made from brass, in a manner similar to Example 1. However, the negative working voltage was set to −280 V and the deposition of the dielectric film on the middle escutcheon of the faucet was conducted in the PECVD chamber for 120 minutes.

### Property Analysis

The dielectric films formed on the showerhead and the middle escutcheon of the faucet in Examples 1 and 2, respectively, were subjected to an acetic acid salt spray test according to ASTM B287, a pencil hardness test according to ASTM 3363-05, and a cross-cut adhesion test according to ASTM D3359-B so as to determine corrosion resistance, hardness and adhesion strength of the dielectric films. The results are shown in the following Table 1.

TABLE 1

| | | Dielectric | Dielectric |
|---|---|---|---|
| | | film formed in | film formed in |
| | Test method | Example 1 | Example 2 |
| Corrosion | ASTM B287 | — | 96 (hours) |
| resistance | | | |
| Hardness | ASTM 3363-05 | 9H | 9H |
| Adhesion | ASTM D3359-B | 5B | 5B |
| strength | | | |

According to the results shown in Table 1, the transparent dielectric films formed by the method of this invention exhibit good corrosion resistance, sufficient hardness against abrasion resistance, and strong adhesion strength to the substrates. In particular, the dielectric film obtained from Example 2 has a contact angle of about 100° and thus, has a good water-repellant property. Consequently, the dielectric films obtained from the method according to this invention are suitable for application to bathroom products.

In addition, since the method for forming a dielectric film on a substrate according to this invention involves the step of removing undesired electrical charges accumulated on the deposited dielectric film on the substrate during application of a working voltage to an electrode in the deposition chamber, generation of arc on the deposited dielectric film can be prevented.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method for forming a dielectric film on a substrate through reaction of a reactant mixture in a deposition chamber, the reactant mixture being dissociated and ionized by a plasma generated in the deposition chamber, the method comprising:
applying a bipolar pulse to an electrode in the deposition chamber such that the bipolar pulse has a cycle time including a first period of a first working voltage of a first polarity for enabling dissociation and ionization of the reactant mixture, and a second period of a second working voltage of a second polarity for removing undesired electrical charges accumulated on the deposited dielectric film on the substrate, the second polarity being opposite to the first polarity.

2. The method of claim 1, wherein the bipolar pulse has a duty cycle defined as the ratio of the first period to the cycle time and ranging from 40 to 95%.

3. The method of claim 2, wherein the duty cycle ranges from 60 to 95%.

4. The method of claim 2, wherein the duty cycle ranges from 80 to 95%.

5. The method of claim 1, wherein the first working voltage has a negative polarity and ranges from −100 V to −400 V.

6. The method of claim 5, wherein the first working voltage ranges from −100 V to −300 V.

7. The method of claim 6, wherein the second working voltage has a positive polarity and ranges from larger than 0 V to +75 V.

8. The method of claim 1, wherein the reactant mixture includes an oxidant selected from the group consisting of oxygen gas and ozone gas, and an organosilicon material selected from the group consisting of tetramethyldisiloxane (TMDSO) and hexamethyldisiloxane (HMDSO), and is carried by an argon gas to flow into the deposition chamber.

9. The method of claim 8, wherein the oxidant is oxygen gas, the volume flow rate of the oxygen gas to the argon gas ranging from 1:2 to 2:1.

10. The method of claim 1, wherein the bipolar pulse has a frequency equal to the inverse of the cycle time and ranging from 10 to 250 kHz.

11. The method of claim 1, wherein the deposition chamber is maintained in a working pressure ranging from 1 Pa to 100 Pa during application of the bipolar pulse to the electrode.

12. The method of claim 1, wherein the deposition chamber is maintained in a working pressure ranging from 1 Pa to 10 Pa during application of the bipolar pulse to the electrode.

13. A method for forming a dielectric film on a substrate through reaction of a reactant mixture in a deposition chamber, the reactant mixture being dissociated and ionized by a plasma generated in the deposition chamber, the method comprising:
applying a first working voltage of a first polarity to an electrode in the deposition chamber for enabling dissociation and ionization of the reactant mixture; and
removing undesired electrical charges accumulated on the deposited dielectric film on the substrate.

14. The method of claim 13, wherein application of the first working voltage to the electrode is conducted intermittently, and removal of the undesired electrical charges accumulated on the deposited dielectric film is conducted at the interval of the application of the first working voltage.

15. The method of claim 14, wherein removal of the undesired electrical charges accumulated on the deposited dielectric film is conducted by applying a second working voltage of a second polarity opposite to the first polarity to the electrode.

16. The method of claim 15, wherein the first working voltage has a negative polarity and ranges from −100 V to −400 V.

17. The method of claim 16, wherein the first working voltage ranges from −100 V to −300 V.

18. The method of claim 17, wherein the second working voltage has a positive polarity and ranges from larger than 0 V to +75 V.

19. The method of claim 13, wherein the reactant mixture includes an oxidant selected from the group consisting of oxygen gas and ozone gas, and an organosilicon material selected from the group consisting of tetramethyldisiloxane (TMDSO) and hexamethyldisiloxane (HMDSO), and is carried by an argon gas to flow into the deposition chamber.

20. The method of claim 19, wherein the oxidant is oxygen gas, the volume flow rate of the oxygen gas to the argon gas ranging from 1:2 to 2:1.
